(19) United States
(12) Patent Application Publication
(10) Pub. No.: US 2011/0221202 A1
(43) Pub. Date: Sep. 15, 2011

(54) WIND TURBINE

(75) Inventor: Hans Bernhoff, Uppsala (SE)

(73) Assignee: VERTICAL WIND AB

(21) Appl. No.: 12/998,728

(22) PCT Filed: Dec. 19, 2008
(86) PCT No.: PCT/SE2008/051531

§ 371 Date: May 25, 2011

(51) Int. Cl. F03D 3/06; F03D 9/00; F03D 1/02

(52) U.S. Cl. 290/55; 416/120

(57) ABSTRACT

The invention relates to a wind turbine (1) with a vertical shaft (9) defining a vertical axis. The turbine (1) has a plurality of axially extending blades (2). Each blade (2) is connected to the shaft by at least one arm structure (3). According to the invention each arm structure (3) includes a radially inner section and a radially outer section connected to the inner section. The inner section includes at least three inner rod elements (8). These are connected to the shaft (9) at least there differently located shaft joints. The outer section is connected to the blade (9) at at feast one blade joint 14. The invention also relates to a wind power unit having such a turbine and to a use of the wind power unit.

### FIELD OF INVENTION

The present invention in a first aspect relates to a wind turbine with a vertical shaft defining a vertical axis, the turbine having a plurality of axially extending turbine blades, each blade being connected to the shaft by at least one arm structure.

In a second aspect the invention relates to the use of a wind power unit having such a wind turbine.

All references in the present application to orientations such as “upper”, “lower” etc. relate to the orientation of the wind turbine when mounted on a vertical shaft.

The terms “axial” and “radial” relate to the turbine axis,

By “shaft” in the present application is meant the element that connects the arm structure to the rotor of a generator. Normally the rotor is located axially within the stator and thus has to be axially offset from the connection with the arm structure. If, however, the rotor is located radially outside the stator, the connection to the arm structure does not necessarily have to to be axially offset. In that case the arm structure can be connected to an outer shell of the rotor. This outer shell therefore in the present application is included in what is meant by “shaft”.

### BACKGROUND OF THE INVENTION

During the last decades the interest for generating electrical energy by using wind turbines has been increased dramatically as a result of the need to exploit alternative sources for that purpose. Most wind turbines, in particular those who have reached commercialization have a horizontal axis and are of the axial flew type.

Although not yet so common, also radial flow turbines with vertical axis are generally known. These so called H-rotors have many advantages in comparison with axial flow turbines, such as a large exposure area towards the wind, independence of the wind direction and the possibility to arrange the generator at the ground. Examples of such wind turbines are disclosed e.g. in U.S. Pat. No. 6,320,273 and U.S. Pat. No. 7,126,235.

In order to attain a wind power unit with vertical axis that is competitive to conventional units having axial flow turbines and to other sources for generating energy it is important to optimize the various elements in such a unit.

The object of the present invention is to optimize the arm structures that connect the blades to the shaft in this kind of turbine in respect of strength properties and the aerodynamic aspects.

It is important that the arm structures on the one hand are stiff and rigid to withstand the torque generated and to avoid vibrations. On the other hand the arm structure should have low inertia and low air drag. The object of the present to invention is thus more specifically to develop a wind turbine with arm structure that meet these partly contradictionary demands.

### SUMMARY OF INVENTION

The object of the invention is achieved in that a wind turbine of the kind initially specified includes the specific features that each arm structure includes a radially inner section and a radially outer section connected to the inner section, the inner section includes at least three inner rod elements connected to the shaft at least three differently located shaft joints and the outer section is connected to the blade at least one blade joint.

The arm structure thereby will have a three point contact with the shaft which results in an advantageous distribution of the forces transferred from the arm structure to the shaft in comparence with conventional design where it is only one single shaft joint. Further, since the inner section is made up by at least three rod elements the advantageous force distribution is achieved with a comparatively low amount of material, which leads to low inertia and low air drag. The force distribution on an arm structure connecting the blade of a vertical wind turbine with the shaft is such that the load is decreasing with increasing radial distance from the shaft. The outer section therefore can be made comparatively weaker, than the inner arm section. Since the velocity is higher at the outer section the aspect of minimizing the air drag is more important for that section than for the inner one. The over all result of an arm structure according to the invention is thus high strength combined with advantageous dynamic, leading to an increased efficiency compared to conventional design.

According to a preferred embodiment the outer section has one single outer rod element, which is connected to all the inner rod elements.

This is normally the most effective way of obtaining a less bulky outer section with a minimized air drag.

According to a further preferred embodiment the inner section has an extension corresponding to 30-50% of the total length of the arm structure.

This proportion between the arm sections normally represents an optimized balance between the demands of the respective section.

According to a further preferred embodiment at least two of the inner rod elements are inclined in relation to the outer rod element, such that the three inner rod elements converge from the shaft towards the outer rod element.

Such construction of the inner section requires a minimum of material for achieving the transition from a central concentration of the arm structure in the outer section to the more wide part adjacent the shaft where the inner section reaches the differently located shaft joints. It is also advantageous in respect of the forces that have to be taken up by the inner rod elements.

According to a further preferred embodiment the shaft joints are distributed in the corners of a triangle.

With this embodiment the arm structure is well adapted to take up the forces to carry the weight as well as the torsion forces in the rotational direction.

According to a further preferred embodiment the triangle has two equally long sides.

Thereby an advantageous symmetry is achieved. Preferably all three sides are equal forming a regular triangle.

According to a further preferred embodiment at least two of the inner rod elements form an angle with the outer rod element that is in the range of 5° to 20°

Within the contemplated proportion of the inner section in relation to the total length of the arm structure, this range for the inclination of the inner rod elements provides an adequate base for the triangle formed by the shaft joints.

According to a further preferred embodiment, the outer rod element has a curved section in a vertical plane.

The optimal vertical location of a blade joint as well as the optimal vertical location of a shaft joint is determined by aspects relating to the blade design and to the support arrangement respectively. The curved extension of the outer rod element allows a greater freedom to choose the vertical location of these joints independently of each other.

According to a further preferred embodiment the outer end of the outer rod element is horizontal.

The blade joint thereby is established by a blade and a rod end that form a right angle to each other which provides good strength in the joint.

According to a further preferred embodiment the outer rod element has a cross section that is decreasing from its radially inner end to its outer end.

The air drag increases with increasing radius whereas the load on the rod to decreases with increasing radius. The decreasing cross section therefore is an advantageous adaption to these conditions.

According to a further preferred embodiment, the cross section is continuously decreasing.

Thereby the rod cross section can be continuously optimized along its entire extension with regards to the air drag and the load requirement. Also any sudden reduction in cross section is eliminated such that stress concentrations are avoided. This shape is also advantageous from a manufacturing point of view.

According to a further preferred embodiment, each blade is connected to the shaft by two arm structures, an upper arm structure and a lower arm structure.

Although the advantages of an arm structure according to the invention in many cases makes it sufficient that each blade is connected to the shaft by one single arm structure, this embodiments will further increase the stiffness and reliability of the turbine. It will also be possible to design each of the two arm structures with weaker rod elements. In particular for wind turbines of large dimensions for which the air drag is considerable the alternative with two arm structures is advantageous.

According to a further preferred embodiment, one of the inner rod elements of the upper arm structure and one of the inner rod elements of the lower arm structure are interconnected and jointly connected to a shaft joint. Such interconnection and the common connection to a shaft joint considerably increase the stiffness of the connection of a blade to the shaft.

According to a further preferred embodiment, the shaft is provided with a radially projecting attachment structure rigidly connected to the shaft and including an upper plate on which at least two shaft joints of each upper arm structure are located and a lower plate on which at least two shaft joints of each lower arm structure is located.

The strength achieved with an arm structure having three or more inner rod elements is larger the wider the base that is provided for the location of the shaft joints is. The plate according to this embodiment provides possibility for a large base for these joints.

According to a further preferred embodiment, the attachment structure further includes at least one intermediate attachment component for each blade which intermediate component has at least one shaft joint for connection to at to least one arm structure, and is located between the upper and lower parts and projects radially from the shaft.

Thereby the base of the location of the shaft joints can be still further increased and be two-dimensional. The triangular distribution of the shaft joints thereby is achieved in an easy way. The shaft joint on the intermediate component can either be common for an inner rod of the upper arm structure and an inner rod of the lower arm structure, or there can be provided separate shaft joints for these two rods.

According to a further preferred embodiment, the intermediate component has an upper end portion rigidly connected to the shaft, a lower end portion rigidly connected to the shaft and a radially projecting middle portion on which is located a shaft joint for the interconnected inner rod elements.

The fixation of the intermediate component at two axially spaced points of the shaft increases its stability, which is particularly advantageous when the two interconnected inner rods are attached to the shaft joint on the intermediate component. This embodiment therefore leads to a particularly robust connection of the blades to the shaft.

The above preferred embodiments of the invented wind turbine are set out in the claims depending on claim 1.

The object of the invention is according to a second aspect achieved in that a wind power unit including an electric generator includes a wind turbine according to the present invention, in particular to any of the preferred embodiments thereof.

According to a third aspect of the invention, the invented wind power unit is used for generating electric energy.

The invented wind power unit and the invented use have advantages corresponding to those of the invented wind turbine, and the preferred embodiments thereof, which advantages have been described above.

The invention will be described further by the following detailed description of various examples thereof and with reference to the accompanying drawings.

### BRIEF DESCRIPTION OF THE DRAWINGS

FIG. 1 is a schematic side view of a wind power unit with a turbine according to the invention.

FIG. 2 is a cross section along line II-II in FIG. 1.

FIG. 3 is a partial side view of a wind turbine according to an alternative example of the invention.

FIG. 4 is a partial side view of a wind turbine according to a still further example of the invention.

FIG. 5 is a partial side view of a wind turbine according to a still further example of the invention.

FIG. 6 is a partial side view of a wind turbine according to a still further example.

FIG. 7 is a perspective view of a detail of a wind turbine according to a still further example.

FIGS. 8-12 are perspective views of further alternative examples illustrating the corresponding detail as in FIG. 7.

FIGS. 13-15 are side view of another detailed according various examples of the invention.

### DESCRIPTION OF EXAMPLES

The wind power unit depicted in FIG. 1 has a wind turbine 1 with a vertical shaft 9. The lower end of the shaft is connected to the rotor of a generator 6. The shaft 9 is journalled in a hollow column 10 by means of bearings 11. The column 10 is supported by wires 5 or rods connected to the ground surface.

The turbine has three vertically extending blades 2 of which only two are illustrated in the figure. Each blade is connected to the shaft by an arm structure 3. The arm structure 3 consists of a radially outer section and a radially inner section. The radially outer section is formed by a rod 7 with its outer end rigidly attached to the blade 2 at a blade joint 14. The radially inner section consists of three rods 8. Each of the inner rods is rigidly connected to the shaft at a respective shaft joint 13. The outer ends of the inner rods 8 are rigidly connected to the inner end of the outer rod 7. The inner rods 8 are inclined in relation to the outer rod 7 and they converge towards the outer rod 7.

The angle between an inner rod 8 and the direction of the outer rod is about 15°. The extension of the inner section is about 40% of the entire extension of the arm structure 3.

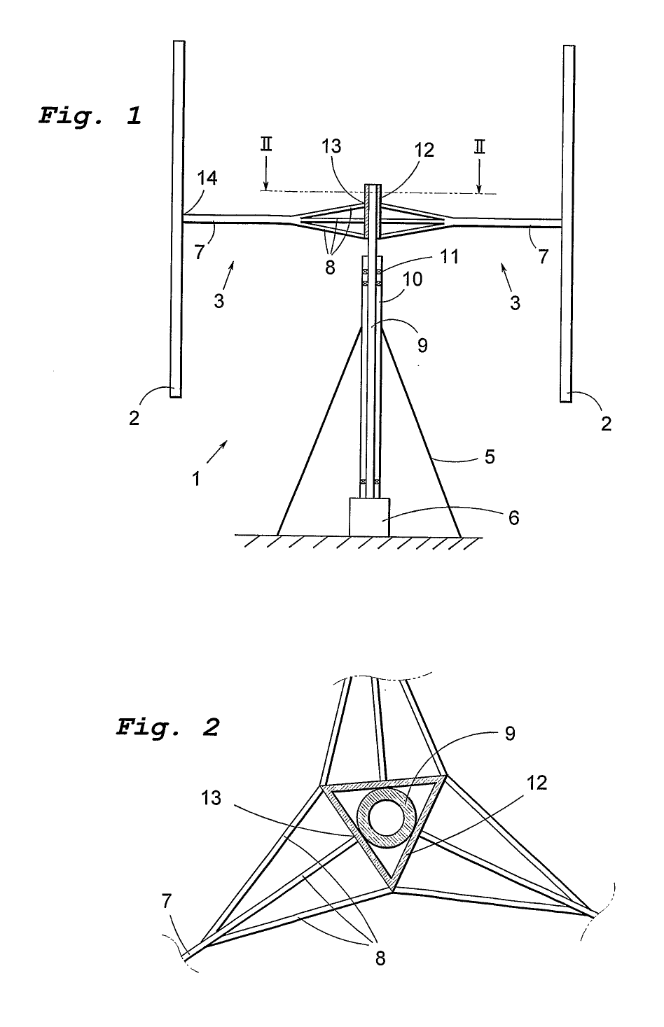

The inner rods 8 are connected to the shaft 9 on an attachment structure 12 on the shaft. The attachment structure 12 is illustrated in FIG. 2 and consists of three plates forming a triangle in a section perpendicular to the axis of the shaft 9.

The plates of the attachment structure 12 are rigidly connected to the shaft 9 e.g. by welding and are also welded together at the corners. Thus the shaft can be seen as having a triangular cross section in the region where the arm structures are attached to the shaft 9. The shaft joints 13 are formed where the inner rods 8 meet the plate of the attachment structure.

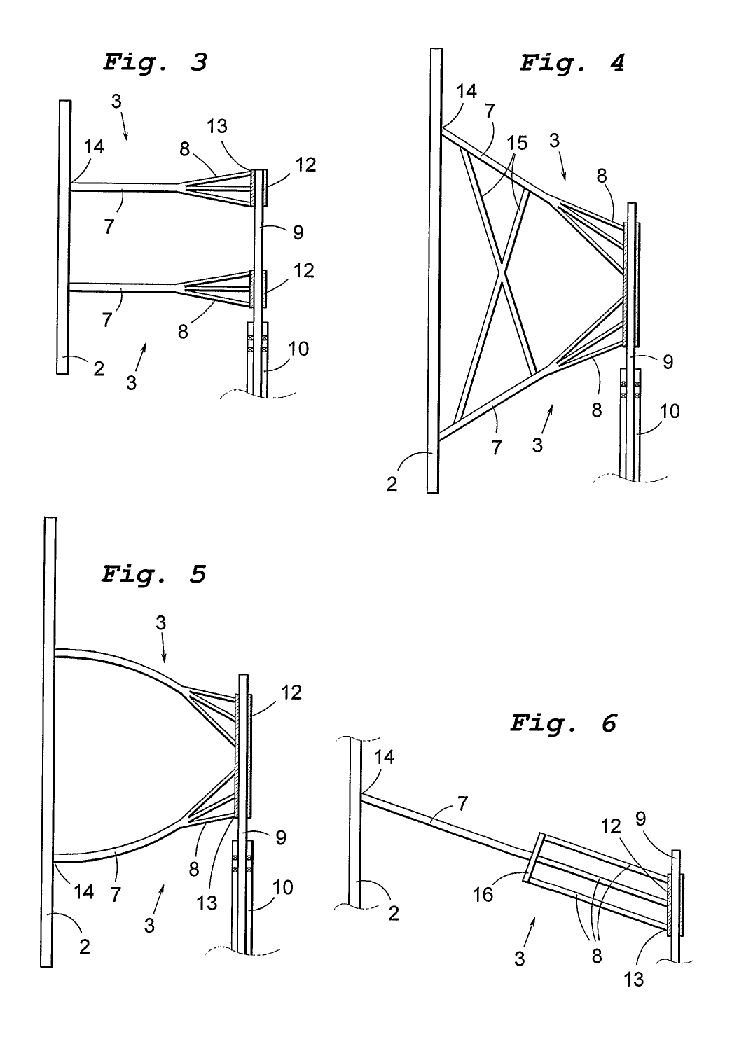

FIG. 3 illustrates an alternative example, however showing only one of the blades and only the upper part of the turbine shaft. The example of FIG. 3 differs from that of FIG. 1 in that there are two arm structures 3 connecting each blade 2 to the shaft 9. Each arm structure 3 in FIG. 3 is similar to the single arm structure of FIG. 1 and is attached to the shaft in a similar way as illustrated in FIG. 2. In most cases it is preferred to have two arm structures due to the better stiffness obtained thereby.

A still further example is illustrated in FIG. 4. Also in this case there are two arm structures 3 for each blade 2. In this example the two arm structures 3 are interconnected by a pair of connection rods 15 in order to increase the stability. Another difference in comparison with FIG. 3 is that the two arm structures 3 diverge in the radially outwards direction. The two arm structures are attached to one single attachment structure 12, whereas in the example of FIG. 3 the attachment structure is divided into two axially separated portions.

In the example of FIG. 5 the outer rod 7 of each arm structure 3 is a bent rod which follows a circular curve in a vertical plane. At the blade joint 14 the outer rod 7 is substantially horizontal and has a continuously increasing inclination towards the inner section of the arm structure. The inner rods 8 are in the illustrated example straight, although also these rods can be bent.

FIG. 6 illustrates another example of an arm structure within the frame of the invention. The inner section is also here built up by these rods 8, which however are parallel to each other and are connected to the outer rod in a plate or a rod 16.

FIG. 7 illustrates a particularly advantageous example of the attachment structure and the inner section of two arm structures. In this example the attachment structure 12a, 12b, 12c consists of an upper plate 12a with the shape of a regular triangle, a lower plate 12b with a similar shape and an intermediate attachment component 12c.

The upper 12a and lower 12b plates are rigidly connected to the shaft, e.g. by welding.

The intermediate component 12c is formed as a rod that is bent in the middle portion thereof and this middle portion projects radially outwards from the shaft 9. The upper and lower end portions of the intermediate component 12c are rigidly connected to the shaft 9, e.g. by welding.

The inner section of the upper arm structure has two of its inner rods 8 connected to one edge side of the upper plate 12a, at a respective shaft joint 13. In a corresponding manner the lower arm section is connected to the shaft joints at the lower plate 12b.

One of the inner rods 8 of the upper arm section is connected to one of the inner rods 8 of the lower arm section. At the connection point of these rods, they are attached to the shaft joint 13 on the intermediate component 12c on the shaft 9.

In FIG. 7 the attachment of the arm structures of only one blade is illustrated. It is to be understood that the other edge sides of the triangular plates 12a, 12b, are connected in a similar way to the arm structures of the other two blades, and that a further intermediate component 12c is facing each of those two blades.

The arrangement is illustrated for a three-bladed turbine. If the turbine has four or five blades, the plates are shaped as a square or a regular pentagon, respectively, and the number of intermediate components 12c is four or five, respectively.

The intermediate component 12c alternatively can be made up of two rods that are interconnected at the shaft joint 13.

As an alternative, the intermediate component 12c can be deleted such that the interconnected inner elements 8 are attached to a common shaft joint directly on the shaft. A further possibility is that the intermediate component 12c is attached with its two ends at a respective plate 12a, 12b.

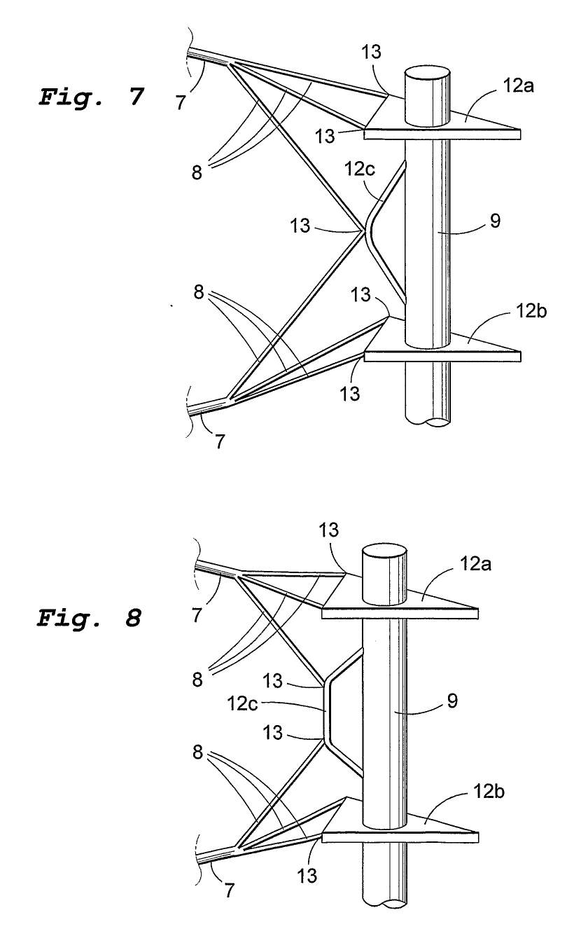

Some further modifications of the attachment structure of FIG. 7 are illustrated in FIGS. 8-10.

In FIG. 8 the intermediate component 12c has two shaft joints 13, connected to an inner rod element 8 of the upper and lower arm structure, respectively.

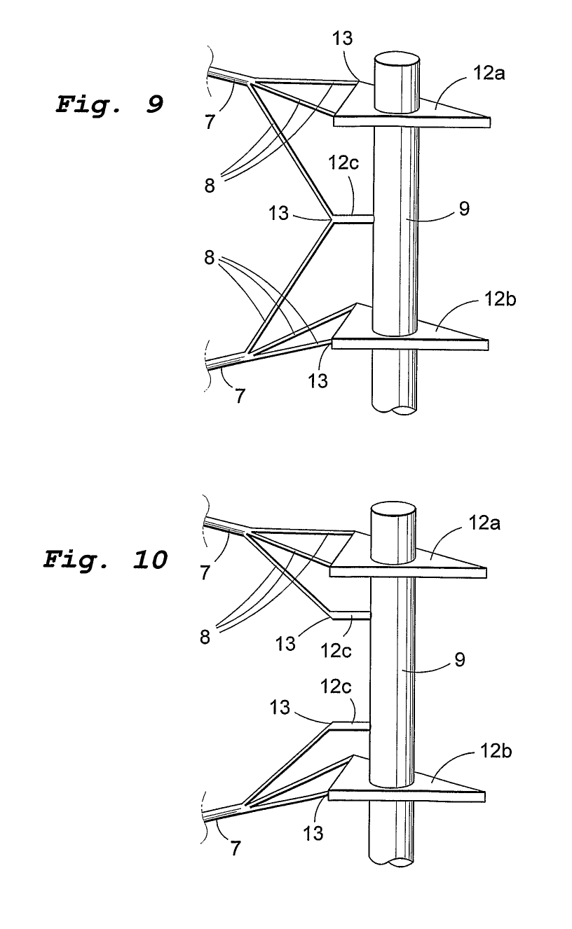

In FIG. 9 the intermediate element 12c is a pin having a common shaft joint 13 for a rod element 8 of the upper and lower arm structure, respectively.

And in FIG. 10 there are two pin-shaped intermediate elements 12c, each connected to an inner rod element 8 at a respective shaft joint 13.

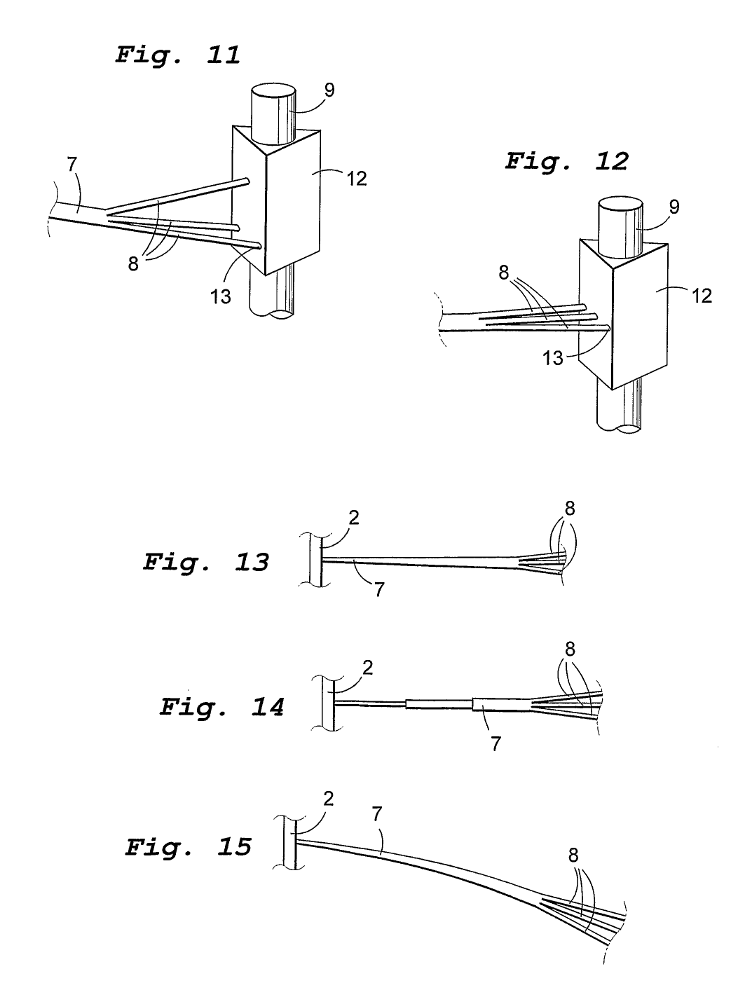

The perspective view of FIG. 11 illustrates a still further example of the attachment of the inner rods 8 to the attachment structure 12 of the shaft 9. The three inner rods 8 are located such that they form a regular triangle, with the two lower shaft joints 13 on a common horizontal line and the third shaft joint being located centrally above them.

FIG. 12 in a similar view illustrates an example where the shaft joints 13 of all the three inner rods 8 are located on a common horizontal line.

FIGS. 13-15 illustrate examples of the outer rod element 8 of an arm structure, where the cross section decreases with increased radial distance from the shaft. FIG. 13 illustrates an example where the cross section is continuously decreasing, FIG. 14 an example where it is stepwise decreasing and FIG. 15 an example where a curved outer rod element 7 has decreasing cross section.

The material of the rods in the arm structures can for example be steel, plastic or wood and include reinforcements. The cross sectional shape can be circular, elliptic or aerodynamically adapted or have a particular shape such as an I-beam. The rods can be hollow or homogenous.

The shaft joints 13 and the blade joints 14 as well as the connection between the inner rods 8 and the outer rod 7 can be made in any conventional manner adapted to the material and shape of the rods, for example by welding or bolting.

One of the inner rods can alternatively be formed as a continuation of the outer rod. It is also possible that the all the inner rods and the outer rods are manufactured together in one piece.

Normally the outer rod will be connected to the blade at one single blade joint 14 as illustrated. Within the concept of the invention it is, however, not excluded that the outer end of the outer section is branched a short distance and having two or more blade joints.

1-17. (canceled)

18. (canceled)

19. A wind turbine (1) with a vertical shaft (9) defining a vertical axis, the turbine (1) having a plurality of axially extending turbine blades (2), each blade (2) being connected to the shaft (9) by at least one arm structure (3), characterized in that each arm (3) structure includes a radially inner section and a radially outer section connected to the inner section, the inner section includes at least three inner rod elements (8) connected to the shaft (9) at least three differently located shaft joints (13) and the outer section is connected to the blade (2) at least one blade joint (14), and which outer section has one single outer rod element (7), which is connected to all the inner rod elements (8).

20. The wind turbine according to claim 19, wherein the inner section has a radial extension corresponding to 30-50% of the total radial extension of the arm structure (3).

21. The wind turbine according to claim 19, including at least two of the inner rod elements (8) are inclined in relation to the outer rod element (8), such that the three inner rod elements converge from the shaft (9) towards the outer rod element (7).

22. The wind turbine according to claim 21, wherein the shaft joints (13) are distributed in the corners of a triangle.

23. The wind turbine according to claim 22, wherein in that the triangle has two equally long sides.

24. The wind turbine according to claim 23, comprising at least two of the inner rod elements (8) form an angle with the outer rod element (7) that is in the range of 5° to 20°.

25. The wind turbine according to claim 24, wherein the outer rod element (7) has a curved extension in a vertical plane.

26. The wind turbine according to claim 25, wherein the outer end of the outer rod element (7) is horizontal.

27. The wind turbine according to claim 26, wherein the outer rod element (7) has a cross section that is decreasing from its radially inner end to its outer end.

28. The wind turbine according to claim 27, wherein the cross section is continuously decreasing.

29. The wind turbine according to claim 28, wherein each blade (2) is connected to the shaft by two arm structures (3), an upper arm structure and a lower arm structure.

30. The wind turbine according to claim 29, wherein one of the inner rod elements (8) of the upper arm structure (3) and one of the inner rod elements (8) of the lower arm structure (8) are interconnected and jointly connected to a shaft joint.

31. The wind turbine according to claim 30, wherein the shaft (9) is provided with a radially projecting attachment structure rigidly connected to the shaft (9) and including an upper plate (12a) on which at least two shaft joints (13) of each upper arm structure (3) is located and a lower plate (12b) on which at least two shaft joints (13) of each lower arm structure (3) is located.

32. The wind turbine according to claim 31, wherein the attachment structure further includes at least one intermediate attachment component (12c) for each blade (2), which intermediate component (12c) has at least one shaft joint (13) in connection with at least one arm structure (3) and is located between the upper (12a) and lower (12b) plates.

33. The wind turbine according to claim 32, wherein each intermediate component (12c) has an upper end portion rigidly connected to the shaft (9), a lower end portion rigidly connected to the shaft (9) and a radially projecting middle portion forming a shaft joint (13) for the interconnected inner rod elements (8).

34. A wind power unit including an electric generator (6) wherein the unit includes a wind turbine (1) according claim 33.

35. The use of a wind power unit according to claim 34 for generating electric energy.
